(19) United States
(12) Patent Application Publication
(10) Pub. No.: US 2025/0188235 A1
(43) Pub. Date: Jun. 12, 2025

(54) ANION EXCHANGE MEMBRANE AND METHOD OF MAKING

(71) Applicant: 3M INNOVATIVE PROPERTIES COMPANY, St. Paul, MN (US)

(72) Inventors: Michael A. Yandrasits, Hastings, MN (US); Maria C. Lindsay, Minneapolis, MN (US)

(21) Appl. No.: 18/844,856

(22) PCT Filed: Feb. 9, 2023
(86) PCT No.: PCT/IB2023/051184

§ 371 Date: Sep. 6, 2024

Related U.S. Application Data
(60) Provisional application No. 63/269,272, filed on Mar. 14, 2022.

(51) Int. Cl. C08J 5/22; H01M 8/10; H01M 8/1081

(52) U.S. Cl. CPC C08J 5/2231; H01M 8/1081; C08J 2353/00; H01M 2008/1095; H01M 2300/0082

(57) ABSTRACT

A method for making an anion exchange membrane is provided. A neutral precursor polymer that contains pendant groups that contain a leaving group is converted to a cationic polymer prior to forming the membrane. The cationic polymer contains pendant groups with a quaternary amino group. This method eliminates the need for multiple wet process steps on the membrane after its formation. Further, this method can improve the ease of solvent capture and recycling compared to previous synthesis methods because these steps occur prior to membrane formation.

### GOVERNMENT RIGHTS

This invention was made with Government support under Contract No. 5971-3M-DOE-8433. The Government has certain rights in this invention.

### BACKGROUND

Anion exchange membranes are of interest for use in electrochemical cells. The anion exchange membranes are formed from polymers with cationic functionality (i.e., cationic polymers). This class of membranes enables anions to migrate through the material while the cationic counter charge remains fixed on the polymer backbone. Fabricating the membrane, however, is challenging. Typically, a neutral precursor polymer that contains pendant halogenated alkyl groups is dissolved in an organic solvent, coated on a temporary substrate, and dried. This film is then soaked in a solution of excess tertiary amine resulting in the formation of a pendant group that contains a quaternary amino group with a halide counter ion. Prior to use, the halide can be ion exchanged with another counter ion desired for the application. This process is undesirable since it requires coating out of an organic solvent and multiple wet-process steps on the film prior to formation of a membrane that is ready for use.

### SUMMARY

A method for making an anion exchange membrane is provided. A neutral precursor polymer is converted to a cationic polymer prior to forming the membrane. The cationic polymer contains pendant groups that contain quaternary amino groups. This method of making the anion exchange membrane eliminates the need for multiple wet process steps on the membrane after its formation to convert the neutral precursor polymer to the cationic polymer. Further, this method can improve the ease of solvent capture and recycling compared to previous synthesis methods because these steps occur prior to membrane formation.

A method of preparing a membrane comprising a cationic polymer is provided. The membrane can function as anion exchange membrane. The method includes (a) providing a precursor polymer comprising x repeat units of Formula (I) and y repeat units of Formula (II).

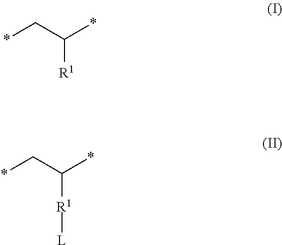

In Formula (I), each R¹ is independently an aralkyl or substituted aralkyl. In Formula (II), each R² is independently an alkylene having at least 4 carbon atoms and each L is independently a leaving group. The variable x represents an overall mole fraction of the repeat units of Formula (I) in the precursor polymer and the variable y represents an overall mole fraction of the repeat units of Formula (II) in the precursor polymer. The method further includes (b) reacting the repeat units of Formula (II) in the precursor copolymer with an amine compound comprising a tertiary amino group to form the cationic polymer having a plurality of cationic repeat units of Formula (III).

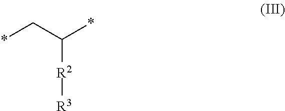

In Formula (III), each R³ is of formula {—[N(R⁴)₂⁺]—R⁵}ᵥ—[N(R⁴)₃]⁺ where each R⁴ is an alkyl and each R⁵ is an alkylene. The variable v is an integer in a range of 0 to 10. Each asterisk (*) represent a point of attachment of a repeat unit to another repeat unit or to a terminal group in the precursor polymer or the cationic polymer. The method still further includes (c) forming a dispersion comprising particles of the cationic polymer, (d) preparing a coating layer from the dispersion; and (e) drying the coating layer to form the anion exchange membrane comprising the cationic polymer.

As used herein, the term “a”, “an”, and “the” are used interchangeably and mean one or more.

As used herein, the term “and/of” is used to indicate one or both stated cases may occur, for example A and/or B includes, (A and B) and (A or B). Thus, the term can be used to mean A alone, B alone, or both A and B.

As used herein, the term “anion exchange membrane” refers to a membrane comprising a cationic polymer that allows for selective transport of anions.

As used herein, the term “polymer” refers to a reaction product of a plurality of monomers having ethylenically unsaturated groups with the polymer having a number average molecular weight (Mn) of at least 5,000 Daltons, at least 10,000 Daltons, at least 25,000 Daltons, at least 50,000 Daltons, at least 100,000 Daltons, at least 300,000 Daltons, at least 500,000 Daltons, at least 750,000 Daltons, at least 1,000,000 Daltons, or even at least 1,500,000 Daltons. The term “polymer” includes homopolymers, copolymers, terpolymers, and the like. The term “copolymer” is often used herein to refer to polymers having at least two different types of monomeric units.

The term “repeat unit” refers to monomeric units within a polymer. For example, the repeat units of Formula (I)

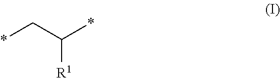

are formed from a monomer of formula CH₂═CHR¹.

As used herein, an asterisk (*) is used to indicate the point of attachment of a repeat unit within a polymeric material to another group within the polymeric material such as another repeat unit or to a terminal group.

As used herein, the term “alkyl” refers to substituted or unsubstituted monovalent radical of an alkane. The alkyl can be linear, branched, cyclic, or a combination thereof. The alkyl group often contains 1 to 40 carbon atoms. For example, alkyl can have at least 1, at least 2, at least 3, at least 4, at least 6, at least 8, at least 10, at least 12, or at least 16 carbon atoms and up to 40, up to 30, up to 20, up to 16, up to 12, up to 10, up to 8, up to 6, or up to 4 carbon atoms. Examples of alkyl groups include, but are not limited to, methyl, ethyl, n-propyl, n-butyl, n-pentyl, n-hexyl, n-heptyl, n-octyl, isopropyl, iso-butyl, sec-butyl, t-butyl, neopentyl, isopentyl, 2-dimethylpropyl, and cyclohexyl.

As used herein, the term “alkylene” refers to substituted or unsubstituted divalent radical of an alkane. The alkylene can be linear, branched, cyclic, or a combination thereof. The alkylene group often contains 1 to 40 carbon atoms. For example, alkylene can have at least 1, at least 2, at least 3, at least 4, at least 6, at least 8, at least 10, at least 12, or at least 16 carbon atoms and up to 40, up to 30, up to 20, up to 16, up to 12, up to 10, up to 8, up to 6, or up to 4 carbon atoms. Examples of alkylene groups include, but are not limited to, methylene, ethylene, n-propylene, n-butylene, n-pentylene, n-hexylene, n-heptylene, n-octylene, and cyclohexylene.

As used herein, the term “aryl” refers to substituted or unsubstituted cyclic aromatic hydrocarbons that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some examples, aryl groups contain about 6 to 14 carbon atoms, 6 to 12 carbon atoms, or 6 to 10 carbon atoms.

As used herein, the term “aralkyl” refers to an alkyl substituted with an aryl group. An aralkyl can be considered as an alkylene bonded to an aryl group. The alkylene can have 1 to 10 carbon atoms (e.g., at least 1, at least 2, at least 3, or at least 4, and up to 8, up to 6, or up to 4 carbon atoms) and the aryl group can have 6 to 10 carbon atoms (e.g., at least 6, at least 8, and up to 10 or up to 8). In some embodiments, the alkylene has 1 to 10 carbon atoms (e.g, 1 to 6 carbon atoms or 1 to 4 carbon atoms) and the aryl is phenyl. The aralkyl group can be substituted or unsubstituted.

As used herein, the term “substituted” broadly refers to a group (e.g., an alkyl group, an aryl group, or an aralkyl group) in which at least one hydrogen atom is replaced with at least one “substituent.” Examples of substituents include, but are not limited to, alkyl groups, halogens (e.g., F, Cl, Br, and I), and various oxygen-containing groups such as hydroxyl groups, alkoxy groups, and aryloxy groups (the oxygen atom is typically the atom connected to the group that is substituted). Examples include an aryl substituted with an alkyl, alkoxy, or halo.

As used herein, the terms “halo” or “halogen” or “halide,” by themselves or as part of another substituent, mean, unless otherwise stated, a fluorine, chlorine, bromine, or iodine atom or ion.

As used herein, the term “leaving group” refers to a group that can be displaced and replaced by a nucleophilic atom, such as a nitrogen atom. Examples of leaving groups include halogens, such as chlorine, bromine, and iodine, which are displaced as chloride, bromide, and iodide; and sulfonyl esters, such as mesyl, tosyl, and nosyl, which are displaced as mesylate, tosylate, and nosylate. While the leaving group can be any suitable leaving group, the leaving group is often bromine.

As used herein, the term “anionic counter ion” refers to anions such as chloride, bromide, iodide, acetate, sulfate, carbonate, or bicarbonate. Anionic counter ion also includes mesylate, tosylate, nosylate, hydroxide, and alkoxide ions. The cationic polymer has anionic counter ions to charge balance the cationic groups. The anionic counter ion may be referred to herein as the “counter ion”.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The term “about” as used herein can allow for a degree of variability in a value or range, for example, within 10%, within 5%, or within 1% of a stated value or of a stated limit of a range.

### DETAILED DESCRIPTION

A process for making an anion exchange membrane is provided. In this method, a neutral (i.e., non-ionic) precursor polymer is converted into a cationic polymer having multiple quaternary amino groups. The cationic polymer is formed prior to formation of the anion exchange membrane. This process is advantageous over prior preparation methods that formed a film from the precursor polymer and then later formed the cationic polymer. Preparation of the cationic polymer prior to film (e.g., membrane) formation advantageously eliminates the need for additional wet processing steps to the film to synthesize the cationic groups. Additionally, solvent capture and recycling is facilitated by conducting the key reaction steps associated with conversion of the precursor polymer to the cationic polymer prior to formation of the anion exchange membrane.

The method includes preparing or providing a precursor polymer that can be converted into the cationic polymer. The precursor polymer comprises x repeat units of Formula (I) and y repeat units of Formula (II).

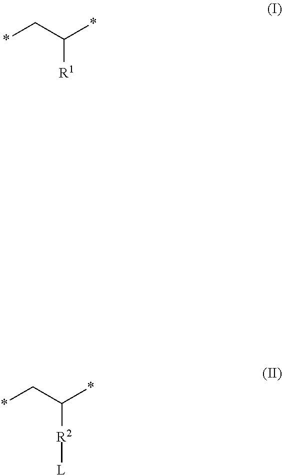

The variable x represents an overall mole fraction of the repeat units of Formula (I) in the precursor polymer and the variable y represents an overall mole fraction of the repeat units of Formula (II) in the precursor polymer. The precursor polymer can be either a random or block copolymer but is often a random copolymer. In Formula (I), each R¹ is independently an aralkyl or a substituted aralkyl. In Formula (II), each R² is independently an alkylene having at least 4 carbon atoms and each L is independently a leaving group.

R¹ in Formula (I) is an aralkyl or substituted aralkyl. The aryl portion of the aralkyl group is often phenyl and the alkylene portion of the aralkyl group often has 2 to 6 carbon atoms, 2 to 4 carbon atoms, or 2 carbon atoms. The aryl portion can optionally be substituted with substituents such as, for example, an alkyl (e.g., an alkyl having 1 to 6 or 1 to 4 carbon atoms), alkoxy (e.g., an alkoxy having 1 to 6 or 1 to 4 carbon atoms), or halogen (e.g., fluorine, bromide, chlorine, or iodine).

The variable x represents the overall mole fraction of the repeat units of Formula (I) in the precursor polymer and in the later formed cationic polymer. In some embodiments, the variable x is in a range of 0.65 to 0.85. For example, the variable x is at least 0.65, at least 0.70, at least 0.75, or at least 0.80 and up to 0.85, up to 0.80, up to 0.75, or up to 0.70.

The sum of variable x and variable y is often equal to 1. There can, however, be additional repeat units other than those of Formula (I) and (II). If other repeat units are present, the sum of x and y is typically at least 0.80, at least 0.85, at least 0.90, at least 0.95, at least 0.97, at least 0.98, or at least 0.99.

Each R² in Formula (II) is an alkylene having at least four carbon atoms. The number of carbon atoms is often in a range of 4 to 20 such as at least 4, at least 5, at least 6, at least 8, or at least 10 and up to 20, up to 18, up to 16, up to 12, up to 10, or up to 8. In some embodiments, each R² is independently a group of formula —(CH₂)ₙ—, wherein n is an integer from 6 to 12, such as an integer ranging from 6 to 10, 8 to 12, or 8 to 10.

The group L in Formula (II) is a leaving group. While L can be any suitable leaving group as defined above, the leaving group is often a halogen such as chlorine, bromine, or iodine, which are displaced as chloride, bromide, and iodide ions when reacted with an amine compound. In many embodiments, L is bromine.

The variable y represents the overall mole fraction of the repeat units of Formula (II) in the precursor polymer. In some embodiments, the variable y is in a range of 0.15 to 0.35. For example, the variable x is at least 0.15, at least 0.20, at least 0.25, or at least 0.30 and up to 0.35, up to 0.30, up to 0.25, or up to 0.20.

The precursor polymer can be prepared using any suitable method. In many embodiments, a Ziegler-Natta catalyst is used to polymerize the monomers used to form the precursor polymer. In such methods, the monomers are dissolved in a non-polar organic solvent such as, for example, toluene, an alkane, a xylene, or the like, or a combination thereof. The Ziegler-Natta catalyst is then added to the monomer-containing solution to form the reaction mixture. Any suitable Ziegler-Natty catalyst can be used. The catalysts can be, for example, titanium trichloride, titanium tetrachloride, vanadium tetrachloride, titanium metallocene (e.g., titanocene dichloride), zirconium metallocene, or combinations thereof. The catalysts are often used in combination with a co-catalyst or activator. For example, diethyl aluminum chloride, triethylaluminum, or triisobutyl aluminum is often used as the co-catalyst, which can be referred to as an activator, for use with titanium trichloride, titanium tetrachloride, or vanadium tetrachloride while methyl aluminoxane (MAO) is often used as the co-catalyst for use with titanium metallocene or zirconium metallocene.

Typically, the precursor polymer initially forms as a gel-like polymer as the molecular weight increases. This gel-like polymer can be fully precipitated as the precursor polymer by the addition of an alcohol such as methanol. The precipitated precursor polymer material can be collected, broken into small pieces, and dissolved in a non-polar solvent such as toluene for purification purposes. This additional step can facilitate removal of the catalyst and any remaining monomers. The dissolved precursor polymer can then be precipitated again by the addition of an alcohol such as methanol, ethanol, isopropanol, or a mixture thereof. The purified precursor polymer can then be collected and dried. Any suitable drying method can be used. For example, the precursor polymer can be dried under vacuum at temperature ranging from about 20 to about 75 degrees Celsius.

The method further includes reacting the repeat units of Formula (II) of the precursor polymer with an amine compound having a tertiary amino group to form the cationic polymer having z repeat units of Formula (III).

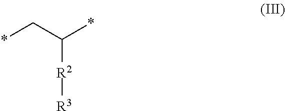

In Formula (III), each R³ is a cationic group of formula {—[N(R⁴)₂⁺]—R⁵}ᵥ—[N(R⁴)₃]⁺ where each R⁴ is an alkyl, each R⁵ is an alkylene, and the variable v is an integer in a range of 0 to 10. As with the repeat units of Formula (II), each asterisk (*) in Formula (III) represents a point of attachment of a repeat unit to another repeat unit or to a terminal group in the cationic polymer. The group R³ has one or more corresponding anionic counter ions to charge balance the cationic groups.

Each R⁴ is an alkyl group. The alkyl groups often have 1 to 10 carbon atoms. For example, the alkyl can have at least 1, at least 2, at least 3, or at least 4 and up to 10, up to 8, up to 6, or up to 4 carbon atoms.

Each R⁵ is an alkylene. In most embodiments, the alkylene has 4 to 12 carbon atoms or 6 to 12 carbon atoms. For example, the alkylene can have at least 4, at least 6, at least 8, or at least 10 and up to 12, up to 10, or up to 8 carbon atoms.

The variable v is in a range of 0 to 10 such as 0, at least 1, at least 2, at least 3, or at least 4 and up to 10, up 8, up to 6, up to 4, or up to 3. When v is 0, the group R³ is equal to —[N(R⁴)₃]⁺. That is, R³ contains a single cationic group. Such groups can be formed by reaction of the monomeric units of Formula (II) with a tertiary amine compound of formula N(R⁴)₃. The group R⁴ in the tertiary amine compound is often methyl, ethyl, or propyl (i.e., the tertiary amine compound is respectively trimethylamine, triethylamine, or tripropylamine). In other embodiments, group R³ contains multiple cationic groups. For these groups, the variable v in the formula {—[N(R⁴)₂⁺]—R⁵}ᵥ—[N(R⁴)₃]⁺ is an integer in a range of 1 to 10. Such groups can be formed by reaction of the monomeric units of Formula (II) with a cationic amine of formula N(R⁴)₂—R⁵—{[N(R⁴)₂⁺]—R⁵}ᵥ₋₁—[N(R⁴)₃]⁺ having a tertiary amino group and one or more quaternary amino groups. Any suitable counter anion may be present to balance the charge of the cationic groups.

The cationic amines of formula N(R⁴)₂—R⁵—{[N(R⁴)₂⁺]—R⁵}ᵥ₋₁—[N(R⁴)₃]⁺ can be prepared using any suitable method. An example compound is 1-(N′,N′-dimethylamino)-6,11-(N,N,N-trimethylammonium) undecane bromide and this compound can be synthesized in a manner similar to that described in Chen et al., Journal of Membrane Science, 552, 51-60, 15 Apr. 2018. The CAS Registry lists this compound as N¹-[6-(dimethylamino)hexyl]-N¹,N¹,N⁵,N⁵,N⁵-pentamethyl-1,5 pentanediaminium dibromide. Other compounds can be prepared in a similar manner.

The variable z represents the overall mole fraction of the repeat units of Formula (IV) in the cationic polymer, with random or block monomer repeat unit distribution, wherein z is in a range of 0.15 to about 0.35. For example, the variable z can be at least 0.15, at least 0.20, or at least 0.25 and up to 0.30, up to 0.25, or up to 0.20.

The cationic polymer includes repeat units of Formula (I) as in the precursor polymer. That is, the cationic polymer includes repeat units of both Formula (I) and Formula (III). The cationic polymer can additionally contain repeat units of Formula (II) if these repeat units were not completely converted to repeat units of Formula (III).

To prepare the cationic polymer from the precursor polymer, the precursor polymer is often dissolved in a non-polar solvent such as toluene or other non-polar solvents such as those listed above. The resulting solution of the precursor polymer is combined with an aqueous-based solution containing the amine compound of formula of formula N(R⁴)₃ or N(R⁴)₂—R⁵—{[N(R⁴)₂⁺]—R⁵}ᵥ₋₁[N(R⁴)₃]⁺ (with an appropriate anionic counter anion) as described above. The cationic groups have an appropriate counter anion present to balance for charge balancing. The aqueous-based solution can contain up to 50 weight percent of the amine compound dissolved in water. The resulting mixture is often mixed vigorously to form a suspension containing the cationic polymer. The suspension can be mixed, for example, for a length of time ranging from a day to about 1 week at room temperature (e.g., 20 to 30 degrees Celsius or 25 to 30 degrees Celsius) to about 60 degrees Celsius. The mixture containing the cationic polymer is then typically treated to remove as much liquid as possible. This can be done, for example, by filtering, using a rotavapor, or both.

In many embodiments, the counter ion of the cationic polymer is bromide. If desired, an optional ion exchange reaction can occur to replace the bromide with another anion. Suitable replacement anions include, but are not limited to, chloride, iodide, carbonate, bicarbonate, and hydroxide. In some embodiments, the anion is chloride. To perform this ion exchange, the cationic polymer is mixed with a brine solution. After mixing, the excess brine is removed by filtration and then washing of the filtered cationic polymer. The washed cationic polymer is often filtered again. The filtered solids are often in a range of about 10 to about 30 weight percent solids.

The washed cationic polymer is often then suspended in a liquid mixture of water and a polar organic solvent such as, for example, tetrahydrofuran. Other suitable polar organic solvents include, but are not limited to, alcohols (e.g., methanol, ethanol, n-propanol, and iso-propanol), and ethers (e.g., tetrahydrofuran, dimethyl ether, diethyl ether, dipropyl ether, ethylene glycol, propylene glycol, propylene glycol butyl ether, and propylene glycol dibutyl ether). The liquid mixture often contains a volume ratio of water to polar organic solvent in a range of 2:1 to 1:2. The volume ratio of water to polar organic solvent can be up to 2:1, up to 1.75:1, up to 1.5:1, up to 1.25:1, or up to 1:1 and at least 1:2, at least 1:1.75, at least 1:1.5, at least 1:1.25, or at least 1:1. The suspension often contains about 1 to 20 weight percent cationic polymer. The amount can be at least 1, at least 2, at least 3, at least 5, or at least 10 and up to 20, up to 15, or up to 10 weight percent. The cationic polymer is typically swollen with the liquids in the suspension.

The suspension containing the swollen cationic polymer is often subjected to high shear mixing to break up the cationic polymer into small pieces. After high shear mixing, the suspension often contains particles of the cationic polymer with an average size in a range of about 10 to 20 micrometers such as close to 15 micrometers. The particle size distribution can be as large as 100 micrometers or even greater, however. The size is based on the longest dimension of the particles.

The method still further includes forming a dispersion containing particles of the cationic polymer. The suspension is typically passed one or more times through a microfluidizer to reduce the average particle size to less than 1 micrometers (i.e., 1000 nanometers). The number of passes is often at least 1, at least 2, at least 3, at least 4, or at least 5 and up to 10, up to 8, up to 6, or up to 4. In many embodiments, 2 or 3 passes are used. The average particle size is often less than 1000, less than 800 nm, less than 600 nm, less than 500 nm, less than 450 and at least 200 nm, at least 250, at least 300 nm, or at least 400 nm. In some embodiments, the average particle size is in a range of 200 to 500 nm, in a range of 200 to 450 nm, or in a range of 250 to 450 nm.

The dispersion is typically concentrated using an ultrafiltration process such as, for example, tangential flow filtration. Ultrafiltration can be advantageously used to remove liquids at room temperature and the product tends to be less aggregated compared to other processes such as using a rotavapor. After ultrafiltration, the dispersion often contains 1 to 20 weight percent, or 5 to 20 weight percent solids based on a total weight of the dispersion. The percent solids can be at least 1, at least 2, at least 5, at least 10, or at least 15 and up to 20, up to 15, or up to 10 weight percent based on a total weight of the dispersion.

The method yet further includes preparing a coating layer from the dispersion. The coating layer is typically formed on a removable support layer. The removable support layer is a temporary substrate used to support the membrane during its fabrication. Any suitable removable support layer can be used. Further, the coating layer may contain a reinforcement layer in addition to the cationic polymer. That is, the reinforcement layer is positioned within the coating layer.

The coating layer is typically deposited on a removable support layer. In some embodiments, the removable support layer is a release liner. The release liner is often a polymeric film that can be optionally coated with a release material. Suitable polymeric films include, but are not limited to, polytetrafluoroethylene (PTFE) or other synthetic polymers formed from tetrafluoroethylene, a polyalkylene (e.g., polyethylene, polypropylene, or a copolymer thereof), or a polyester film such as polyethylene terephthalate. These polymeric films can optionally be coated with a release material such as a fluorinated material or a silicone material. In other embodiments, the removable support layer can be, for example, prepared from glass or any other material that can be easily separated from the coating layer after it has been dried. That is, the removable support layer is removed before use of the membrane.

The coating layer can optionally include a porous reinforcement material in addition to the cationic polymer. That is, the coating layer can be a composite material. To position the porous reinforcement material within the coating layer, a first coating layer is often deposited on a removable support layer. Then the porous reinforcement material is positioned adjacent to the first coating layer opposite the removable support layer. A second coating layer is deposited such that the porous reinforcement material is positioned between the first coating layer and the second coating layer. At least some of the coating layer composition typically imbibes the pores of the porous reinforcement material.

Suitable porous reinforcement materials include, but are not limited to, woven and non woven materials made of a fluoropolymer such as polytetrafluoroethylene, polyethylene, polypropylene, electrospun nanofibers, fiberglass, polymer fibers, fiber mats, perforated films, and porous ceramics. The pores of the porous reinforcement material can be imbibed (e.g., saturated or coated) with the coating layer composition. The porous support is often selected so that it is electrically non-conductive. The porous reinforcement material is typically relatively thin and is present for reinforcement purposes. The thickness of the porous reinforcement material can have any suitable thickness but is often selected to be up to 10, up to 8, up to 6, up to 5, up to 4, up to 2 or up to 1 micrometer.

The method still further includes drying the coating layer to form a membrane comprising the cationic polymer. The coating layer can be dried in any suitable manner. For example, the coatings can be dried in a forced-air oven at a temperature in a range of about 65 to 110 degrees Celsius. In some embodiments, the coating is dried for 30 to 60 minutes.

In some embodiments, the membrane is primarily composed of the cationic polymer. In other embodiments, the membrane further includes the porous reinforcement material embedded within the cationic polymer. That is, the membrane is a composite material containing the porous substrate and the cationic polymer.

Any removable support layer that was used to form the membrane is removed prior to use of the membrane.

The membrane can have any desired thickness. The thickness is often less than 100, less than 80, less than 60, less than 50, less than 40, less than 30, or even less than 25 micrometers.

The membrane contains the positively charged cationic polymer and can function as an anion exchange membrane. Thus, the membrane can be referred to interchangeably as an anion exchange membrane or a polymeric anion exchange membrane.

The polymeric anion exchange membranes can have a swelling ratio. The swelling ratio can be characterized by the linear expansion ratio either in the chloride form or in the hydroxide form, which can be determined using the difference between wet and dry dimensions of a membrane sample (e.g., a sample measuring 3 cm in length and 1 cm in width) using equation (1):

$$SW ( \% ) = \frac{{X}_{wet} - {X}_{dry}}{{X}_{dry}} \times 100 \% \qquad ( 1 )$$

where X_{wet} and X_{dry} are the lengths of a wet and a dry membrane, respectively.

The swelling ratio in the chloride form can be less than about 60%, less than about 50%, less than about 40%, less than about 30%, less than about 20%, less than about 10% or less than about 5%. For example, the swelling ratio can be, on the upper end, about 60%, about 55%, about 50%, about 45%, about 40%, about 35% or about 30% and, on the lower end, about 25%, about 20%, about 15%, about 10%, about 5% or about 1%.

The swelling ratio in the hydroxide form can be less than about 90%, less than about 85%, less than about 80%, less than about 75%, less than about 70%, less than about 65%, less than about 60%, less than about 55%, less than about 50%, less than about 45%, less than about 40%, less than about 35% or less than about 30%. For example, the swelling ratio can be, on the upper end, about 90%, about 80%, about 70%, about 60% or about 50% and, on the lower end, about 45%, about 40%, about 35%, about 30%, about 25% about 20%, about 10%, or about 5%.

The anion exchange membranes can be placed between two electrodes, the anode and cathode, of an electrochemical device. In some embodiments, the electrode is a gas diffusion electrode comprising a gas diffusion layer coated with a catalyst. Gas diffusion layers are known in the art and include for example carbon paper or cloth, or a metal mesh.

Examples of electrochemical devices include, but are not limited to, solid-state fuel cells, electrolyzers, chlor-alkali cells, solid polymer electrolyte batteries, redox flow batteries or electrochemical desalination devices.

Electrode materials can include, for example, graphitic carbon, glassy carbon, titanium, or any of the following “catalytically active elements”: V, Cr, Mn, Fe, Co, Ni, Cu, Sn, Zr, Nb, Mo, Ru, Rh, Pd, Ag, Cd, Hf, Ta, W, Re, Ir, Pt, Au, Hg, Al, Si, In, Tl, Pb, Bi, Sb, Te, U, Sm, Th, La, Ce, Nd, and alloys or combinations thereof.

In one embodiment, the electrochemical device comprises catalytically active nanoparticles. The nanoparticles may be supported on carbon particles or nanostructured supports, such as carbon nanotubes or nano structured thin films (NSTF) as disclosed in, e.g., U.S. Pat. No. 8,748,330 (Debe et al.).

In one embodiment, the electrochemical device comprises an extended surface area catalyst-based electrode such as a nanostructured thin film electrode, nanotube electrode, porous sponge electrode, or two-dimensional polycrystalline film electrode.

In one embodiment, the cathode of the electrochemical device comprises a metal selected from silver, gold, copper, or combinations thereof.

In one embodiment, the anode of the electrochemical device comprises a metal selected from ruthenium, iridium, platinum, titanium, or combinations thereof. In one embodiment, the electrochemical device is substantially free of platinum, meaning the electrode comprises less than 0.1%, less than 0.01% or even less than 0.001% by weight of platinum.

The cathode, the anode, and/or polymeric anion exchange membrane described herein can be assembled each as a separate component or can be fabricated wherein the polymeric ion exchange membrane (or a portion thereof) is fabricated with one or both electrodes or a portion thereof. For example, to maximize cost savings and in some instances performance, the individual components, or layers thereof, may be sufficiently thin, such that some of the components could act as a support during the fabrication of a thin layer. The various components or portions thereof can be laminated together, formed in situ on a surface of a component, and/or coated onto a component.

The membrane electrode assembly comprising the anode, cathode and polymeric anion exchange membranes described herein can be sandwiched between two flow field plates and then held together such that each layer is in contact, preferably intimate contact, with the adjacent layers.

The polymeric anion exchange membranes can be used within an electrochemical device for producing electricity. The electrochemical device contains an anode, cathode, a polymeric anion exchange membrane, a hydrogen gas input, and an oxygen gas input. The hydrogen gas input is configured to provide a composition comprising hydrogen gas to an anode flow field for oxidation of the hydrogen gas at the anode electrode. The oxygen gas input is configured to provide a composition comprising oxygen gas to a cathode flow field for reduction of the oxygen gas at the cathode electrode.

Additionally, the polymeric anion exchange membranes can be used within an electrochemical device for electrochemically reducing carbon dioxide. The electrochemical devise contains an anode, cathode, a polymeric anion exchange membrane, and a carbon dioxide input. The carbon dioxide input is configured to provide a composition comprising carbon dioxide to a cathode flow field. Electrical energy is supplied to the electrochemical device to effect electrochemical reduction of the carbon dioxide at the cathode. For the reduction of carbon dioxide, the cell is operated at a potential difference equal to or more positive than about 1.33 V, with the highest potential difference being 4.0V, such as within about 2.6 to about 3.4V.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Chemicals used

| Chemical | Description | Source |
|---|---|---|
| 4-Phenyl-1-butene | Monomer | Sigma Aldrich (St. Louis, |
| | | MO, USA) |
| 11-bromo-1-undecene | Monomer | Sigma Aldrich (St. Louis, |
| | | MO, USA) |
| TiCl₃ · AA | An activated grade of TiCl₃ used | VWR International |
| | for Ziegler-Natta catalyst | (Radnor, PA, USA) |
| Triisobutyl aluminum | Ziegler-Natta catalyst | Sigma Aldrich (St. Louis, |
| | | MO, USA) |
| Toluene | Polymerization solvent | Sigma Aldrich (St. Louis, |
| | | MO, USA) |
| Methanol | Quenching solvent | VWR International |
| | | (Radnor, PA, USA) |
| Isopropanol | Quenching/washing solvent | VWR International |
| | | (Radnor, PA, USA) |
| Hydrochloric acid | Acid used for acidification of | VWR International |
| (35 wt-% H₂O) | methanol | (Radnor, PA, USA) |
| Trimethylamine | Quaternization solution | VWR International |
| (50 wt-% H₂O) | | (Radnor, PA, USA) |
| Trimethylamine | MQA reagent | VWR International |
| (2M in THF) | | (Radnor, PA, USA) |
| Tetrahydrofuran (THF) | Solvent | Sigma Aldrich (St. Louis, |
| | | MO, USA) |
| Acetonitrile | Solvent | VWR International |
| | | (Radnor, PA) |
| 1,5-dibromopentane | MQA reagent | Sigma Aldrich (St. Louis, |
| | | MO, USA) |
| N,N,N′,N′-Tetramethyl-1,6- | DQA reagent | Sigma Aldrich (St. Louis, |
| hexanediamine | | MO) |
| 5-Bromopentyl | Compound used in synthesis of | Prepared in Preparatory |
| trimethylammonium bromide | 1-(N′,N′-dimethylamino)-6,11- | Example 3 below |
| (MQA) | (N,N,N-trimethylammonium) | |
| | undecane bromide (DQA) | |
| 1-(N′,N′- | Quaternization compound | Prepared in Preparatory |
| dimethylamino)-6,11- | | Example 3 below |
| (N,N,N-trimethylammonium) | | |
| undecane bromide (DQA) | | |

### Characterization Methods

### NMR of Precursor Polymer

A portion of the precursor polymer sample was analyzed as a solution, typically about 12 mg/mL in dry deuterated chloroform. NMR spectra were acquired on a Bruker AVANCE 500 MHz NMR spectrometer with a cryogenically cooled broad-band probe. Monomer incorporation was determined from the peak areas associated with unique protons from each repeat unit.

### Particle Sizing

A PARTICA LA-950 laser scattering particle size distribution analyzer (Horiba, Irvine, CA) was used to measure the particle size distribution of the cationic polymer before and after microfluidization.

Ion Conductivity while Immersed in Water

The conductivity of the cationic polymer membranes was measured using AC impedance spectroscopy and a four-point probe configuration with platinum wires using a Biologic MPG-205 Battery Cycler with EC-Lab V11.12 software. Samples are cut to 1 cm by 4 cm with a probe spacing of 1 cm. The instrument was run in the current control mode (with the AC amplitude set to 0.1 mA) with frequency cycles from 50,000 to 1 Hz. An impedance spectrum was taken, and the conductivity was calculated from the resistance at the 1000 Hz data point using the following equation.

$$conductivity = t / ( R * w * l )$$

In this equation, conductivity is equal to conductivity (S/cm) where S refers to Siemens, which is a unit of conductivity. Further, t is equal to thickness (cm), w is equal to width (cm), l is equal to length (cm), and R is equal to resistance in Ohms.

Conductivity measurements were performed at room temperature while the sample was immersed in deionized, nitrogen purged water. Samples in the hydroxide form were handled in a nitrogen purged enclosure to prevent the formation of carbonate ions through reaction with ambient carbon dioxide. To obtain reliable average data, samples are usually run in duplicate or triplicate.

### Water Uptake and Linear Swell

Water uptake and linear swell were determined for the cationic polymer membrane by measuring the mass and length of the water swollen membrane at room temperature in either the chloride or hydroxide form. The samples were then dried in a forced air oven at 50° C. for 2 hours followed by dry mass and length measurements. Water Uptake (wt-%) and Linear Swell (%) of the samples in the chloride or hydroxide form respectively were calculated using the following equations.

$$\begin{matrix}WU = 100 * ( {m}_{s} - {m}_{0} ) / {m}_{0} \\ S = 100 * ( {l}_{s} - {l}_{0} ) / {l}_{0}\end{matrix}$$

In these equations, WU refers to water uptake (%), m₀ is equal to the dry mass (g), mₛ is equal to the swollen mass (g), S refers to the amount of swell (%), I₀ is equal to the dry length (cm), and Iₛ is equal to the swollen length (cm).

### Processing Methods

### Microfluidizer (MF) Process (Cationic Polymer Dispersion in THF/Water Using High Shear)

A portion of swollen cationic polymer was mixed with THE and water (approximately 50:50 weight ratio) to form a slurry. Next, a Microfluidics (Westwood, MA) Model M110-F microfluidizer with two interaction chambers arranged in series (H30z 200μ and H10z 100μ) was filled with approximately 30 ml of a THF/water (50:50) mixture. The THF/water solution was circulated through the microfluidizer for approximately 1 minute. The polymer slurry was slowly poured into the circulating THF/water solution. After all the polymer slurry was added to the circulating fluid, the resulting dispersion was collected and concentrated using the tangential flow filtration method described below.

### Tangential Flow Filtration (TFF) Method:

TFF is a separation/concentration method where the sample flows tangential or parallel rather than perpendicular to the filter or membrane. This provides a large surface area and prevents clogging of the filter. TFF works by applying a pressure differential across the filter while the sample is continuously flowing. As appropriately sized particles/solvent (permeate) flow past the pores in the filter, the positive pressure causes them flow through the pores. The remainder of the sample (retentate) continues to flow through the system until the desired amount of permeate has passed through the filter.

Tangential flow filtration (TFF) was performed using a titanium oxide ceramic column, VALISETT 316L SS filtration cell EVAC025000000 obtained from Sterlitech, (Auburn, WA). The columns were one channel, 250 mm long, 10 mm in diameter, and had a pore size of 100 or 300 kg/mol. Alternatively, a modified polyethersulfone hollow filter column obtained from Spectrum Labs (Waltham, MA) was used. This column was 200 mm long with 36 fibers and a total fiber surface area of 1150 mm squared (mm²). The fibers had an inner diameter of 0.5 mm and a pore size of 70 kg/mol.

### PREPARATORY EXAMPLES

### Preparatory Example 1 (PE1): Preparation of Precursor Polymer

The precursor polymer was prepared by Ziegler-Natta polymerization. In a glove box, 4-phenyl-1-butene (56 ml) and 11-bromo-1-undecene (25 ml) were combined in a flask with toluene (325 ml) and stirred gently to form a monomer solution. The catalyst was prepared by mixing triisobutyl aluminum (7.0 ml) and TiCl3·AA (0.6068 g) in a vial with toluene (10 ml) and stirred for thirty minutes at room temperature. The catalyst mixture was then added to the monomer solution. Toluene (10 ml) was used to rinse both the catalytic mixture vial and the top of the flask. The flask was sealed, and the reaction mixture stirred vigorously at room temperature for 24 hours. After two hours, the reaction mixture had turned a dark brown/grey color and a significant amount of polymeric material was visible. After three hours, no further color changes were observed; the sample was very viscous, almost gel-like in appearance. After 24 hours the reaction flask was removed from glove box and the mixture quenched by slowly pouring it into a large container of acidic methanol (1500 ml, 1 drop concentrated HCl in 30 ml methanol) causing the polymer to precipitate. The polymer was manually agitated to ensure that all surfaces were exposed to the acidic methanol. The solid polymer was redissolved in toluene (1000 ml), and reprecipitated in isopropanol (2000 ml) to remove any residual monomer/catalysts. The solid polymer was filtered and dried at 50° C. for 8-18 hours under vacuum. The obtained precursor polymer was an off-white, rubbery solid with an 86% yield. A sample of the precursor polymer was dissolved in deuterated chloroform and characterized using ¹H NMR. A summary of the NMR data is tabulated below in Table 2.

TABLE 2
NMR Data for PE1

| | | Number of | | | |
|---|---|---|---|---|---|
| | Peak | protons | NMR shift | | Peak |
| Proton site | label | (Hₓ) | (ppm) | Peak Area | description |
| —CH₂—Br | A | 2 | 3.35 | 2.00 | broad singlet |
| —CH₂—Ph | B | 2 | 2.59 | 7.27 | broad singlet |
| Ph—H | C | 5 | 7.22 | 18.33 | multiplet |
| —(CH₂)— | D | 28 | 1.27 | 39.60 | multiplet |

The mole fraction incorporation of 4-Phenyl-1-butene (x) in the precursor polymer was determined to be 79% using the following equation:

$$x = \frac{\frac{Peak Area C}{Number of C Protons}}{( \frac{Peak Area A}{Number of A Protons} + \frac{Peak Area C}{Number of C Protons} )} = \frac{18.33 / 5}{( 2 / 2 + 18.33 / 5 )} = 0.79$$

The mole fraction incorporation of 11-bromo-1-undecene (y) in the precursor polymer was determined to be 21% using the following equation:

$$y = \frac{\frac{Peak Area A}{Number of A Protons}}{( \frac{Peak Area A}{Number of A Protons} + \frac{Peak Area C}{Number of C Protons} )} = \frac{2 / 2}{( 2 / 2 + 18.33 / 5 )} = 0.21$$

The structures providing the NMR peaks are identified below.

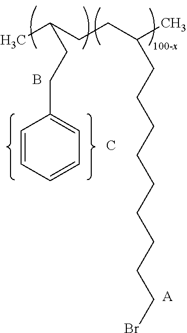

### Preparatory Example 2 (PE2): Preparation of Cationic Polymer (Precursor Polymer PE1 Quaternized with TMA)

The precursor polymer PE1 was converted to the cationic polymer and dispersed in an aqueous solution prior to forming a polymer film. Precursor polymer PE1 (10.1825 g) was dissolved in toluene (250 ml) to create a 4.5 wt % solution in a 1000 ml round bottom flask at room temperature. Trimethylamine (100 ml, 50 wt % H₂O) and deionized (DI) H₂O (150 ml) were then added to the rapidly stirring PE1 solution and the flask was sealed. The immediate development of a polymer slurry and the subsequent formation of a white precipitate were observed within the first 5-10 minutes. The slurry was stirred at room temperature for 24 hours. The solvent and residual (TMA) were removed from the solid by rotary evaporation resulting in a water swollen quaternized polymer. The swollen, quaternized polymer was ion exchanged from the bromide anion form to the chloride anion form by placing the polymer in a saturated solution of sodium chloride (250 ml) and agitating the mixture for 30 minutes to 24 hours. The solid was filtered, and the process was repeated a total of three times. The solid was rinsed and filtered several times with water to remove any excess sodium chloride. The obtained product was a white, semi-solid, water swollen polymer with 29 wt % solids and a 90% yield.

This polymer (31.62 g) was then mixed with methanol and water (50:50 mixture, 175 g) to make a 5 wt % slurry and then mixed with a Silverson SL2T high speed mixer (Silverson Machines, East Longmeadow, MA) to break up any large particles followed by high shear mixing using the Microfluidizer Model M110-F (Microfluidics, Westwood, MA) to form a stable dispersion. The dispersion was passed through the Microfluider a total of three times, collecting all the dispersion before running through the system again. After 48 hours, sedimentation was noted in the dispersion. The dispersion was centrifuged to separate out the sediment and the decant was filtered through a 20 micron polypropylene filter prior to being concentrated using the tangential flow filtration technique (Sterlitech, Auburn, WA). The resulting, stable PE2 dispersion was about 1.24 wt % solids. The average particle size before and after the microfiltration and tangential flow filtration processes are shown in Table 3.

TABLE 3
Particle size of PE2 and PE4 before and after MF/TFF Process

| Sample Name | Average Particle Size (um) |
|---|---|
| PE2 Dispersion: Pre-MF/TFF Process | 10.1 |
| PE2 Dispersion: Post-MF/TFF Process | 0.13 |
| PE4 Dispersion: Pre-MF/TFF Process | TBD |
| PE4 Dispersion: Post-MF/TFF Process | TBD |

### Preparatory Example 3 (PE3): Synthesis of 1-(N′, N′-dimethylamino)-6,11-(N, N, N-trimethylammonium) undecane bromide (DQA)

The multi-cation side chain precursor was prepared in two steps prior to attaching to the precursor polymer. Trimethylamine (125 ml, 2M in THF) was added to a round bottom flask at room temperature and stirred gently. To this solution was added 1,5-dibromopentane (14 ml). The graduated cylinder and top of the flask were rinsed with THE (15 ml). The flask was capped, and the reaction stirred at room temperature for 69.5 hours. The formation of a white precipitate was observed during the reaction. The white precipitate of 5-bromopentyl trimethylammonium bromide (MQA) was filtered and rinsed with THE (75 ml×3). The solid was dried at 50° C. for 8-18 hours under vacuum producing a white crystal consisting of very fine needles in 96% yield. A sample of the solid was dissolved in deuterated dimethyl sulfoxide and characterized using ¹H NMR.

Next, N,N,N′,N′-Tetramethyl-1,6-hexanediamine (125 ml, TMHDA) was added to acetonitrile (400 ml, ACN) in a large round bottom flask and vigorously stirred. Subsequently, MQA (28.00 g) was dissolved in ACN (600 ml) in a separate flask and then slowly poured into the TMHDA/ACN solution. The flask was capped, and the reaction stirred at room temperature for 20 hours. The formation of a while precipitate was observed during the reaction. The ACN was removed from the solid with a rotary evaporator and the solid was filtered and rinsed with hexanes (50 ml×2) to remove any residual TMHDA and ACN. The solid was dried at 50° C. for 8-18 hours under vacuum producing a white powder consisting of very fine needles in 62% yield. A sample of the solid was dissolved in deuterated water and characterized using ¹H NMR.

### Preparatory Example 4 (PE4): Preparation of Cationic Polymer (Precursor Polymer PE1 Quaternized with DQA)

The precursor polymer was converted to a multi-cation side chain polymer and dispersed in an aqueous solution prior to forming a membrane. Quaternized polymer PE4 was made using the method described in Preparatory Example 2 with PE1 (5.07 g) and 1-(N′, N′-dimethylamino)-6,11-(N, N, N-trimethylammonium) undecane bromide (DQA) (16.32 g) in toluene (160 ml) and H₂O (160 ml). This reaction mixture was heated to 60° C. for 4 days. The obtained product was a white, semisolid, water swollen polymer with 13 wt % solids and an 88% yield.

This polymer is then mixed with THF and water to make a slurry followed by high shear mixing using the Microfluidizer to form a stable dispersion. The THF is mostly removed, and the dispersion can be concentrated, using the tangential flow filtration technique (Spectrum Labs, Waltham, MA). The resulting stable PE4 dispersion is expected to be about 5-10 wt % solids with a primary particle size of less than 0.5 microns. The average particle size before and after the microfiltration and tangential flow filtration processes is shown in Table 3.

### EXAMPLES AND COMPARATIVE EXAMPLES

### Example 1 (EX1): Membrane Cast from PE2 (TMA)

The aqueous dispersion of cationic polymer described in Preparatory Example 2 (PE2) was cast to form a composite membrane consisting of the cationic polymer and an expanded poly(tetrafluoroethylene) (ePTFE) reinforcing support type TX1336994-1336 (Donaldson Co., Minneapolis, MN). The ePTFE, which is a porous reinforcement material, was fitted to a polytetrafluoroethylene (PTFE) window frame and pre-wetted on the casting side with ethanol. The PE2 dispersion was slowly poured onto the wetted membrane until the surface inside the window frame was covered. The film was placed in a forced air oven and dried at 100° C. for 30 minutes. The window frame containing the film was then removed from the oven and flipped over and a second layer was cast on the other side of the support in the same manner as the first (without the pre-wetting step). The films were returned to the oven with the wet side up and were dried at 110° C. for 45 minutes. Once dry the film was removed from the window frame and the edges were trimmed. The resulting membrane was analyzed for conductivity, water uptake, and linear swell in water. The resulting membrane was analyzed for conductivity, water uptake, and swell as shown in Tables 4 and 5.

### Example 2 (EX2): Membrane Cast from PE4 (Multi-Cation)

The aqueous dispersion described in Preparatory Example 4 (PE4) is cast to form a membrane with an ePTFE reinforcing support using the method described in Example 1. The resulting membrane is analyzed for conductivity, water uptake, and swell as shown in Tables 4 and 5.

### Comparative Example 1 (CE1): Membrane Cast from PE1, Organic Solvent and Post Quaternized with TMA

The precursor polymer described in Preparatory Example 1 (PE1) was cast to form a composite film consisting of the precursor polymer and an expanded poly(tetrafluoroethylene) (ePTFE) reinforcing support. PE1 (2.52 g) was mixed with toluene (47.55 ml) to create a 5 wt % mixture. The mixture was rolled and shaken for several days until all the polymer was dissolved. The ePTFE support membrane was fitted to a PTFE window frame and pre-wetted on the casting side with isopropanol. The PE1 solution was slowly poured onto the wetted membrane until the surface inside the window frame was covered. The film was placed in a forced air oven and dried at 65° C. for 1 hour. The window frame containing the film was then removed from the oven and flipped over and a second layer was cast on the other side of the support membrane in the same manner as the first (without the pre-wetting step). The films were returned to the oven with the wet side up and were dried at 65° C. for 1 hour. Once dry the film was removed from the window frame and the edges were trimmed. The film was placed in ajar with trimethylamine (100 ml, 50 wt % H₂O) and rolled for 4-5 days before being removed. It was then rinsed with DI water and ion exchanged to the chloride anion form by placing the film in a 2M NaCl solution (100 ml) and sonicating for 30 minutes. The solution was then replaced, and the procedure repeated twice more. Once in the chloride form the cationic polymer membrane was analyzed for conductivity, water uptake, and linear swell in water. The resulting membrane was analyzed for conductivity, water uptake, and swell as shown in Tables 4 and 5.

### Comparative Example 2 (CE2): Membrane Cast from PE1, Organic Solvent and Post Quaternized with DOA

Comparative Example 2 was made using the method described in Comparative Example 1 with a 5 wt % dispersion of PE2 (10.15 g) and toluene (150 g) and quaternized with (1-(N′, N′-dimethylamino)-6,11-(N, N, N-trimethylammonium) undecane bromide (11.15 g) dissolved in DI H₂O (110 ml). The film with the quaternizing solution was placed in a 60° C. oven for 4 days and then ion exchanged. The resulting membrane is analyzed for conductivity, water uptake, and swell as shown in Tables 4 and 5.

TABLE 4
Conductivity data

| Sample | Cl Conductivity (S/cm) | OH Conductivity (S/cm) |
|---|---|---|
| EX1 | 0.0117 | 0.0348 |
| EX2 | TBD | TBD |
| CE1 | 0.0197 | 0.0268 |
| CE2 | TBD | TBD |

TABLE 5
Water uptake and swell data

| | Cl Water | OH Water | | |
|---|---|---|---|---|
| Sample | Uptake (%) | Uptake (%) | Cl Swell (%) | OH Swell (%) |
| EX1 | 80% | 202% | 3% | 5% |
| EX2 | TBD | TBD | TBD | TBD |
| CE1 | 121% | 294% | 10% | 30% |
| CE 2 | TBD | TBD | TBD | TBD |

1. A method of making an anion exchange membrane comprising a cationic polymer, the method comprising:
a) providing a precursor polymer comprising x repeat units of Formula (I) and y repeat units of Formula (II) 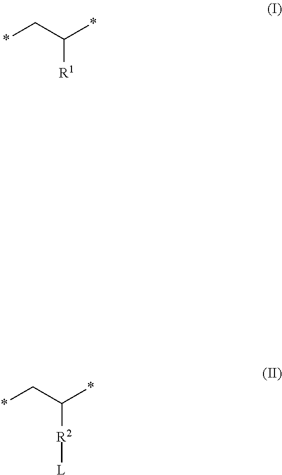
wherein
each R¹ is independently an aralkyl or a substituted aralkyl;
each R² is independently an alkylene having at least 4 carbon atoms;
each L is independently a leaving group;
x represents an overall mole fraction of the repeat units of Formula (I) in the precursor polymer; and
y represents an overall mole fraction of the repeat units of Formula (II) in the precursor polymer; and
b) reacting the repeat units of Formula (II) of the precursor copolymer with an amine compound comprising a tertiary amino group to form the cationic polymer having a plurality of cationic repeat units of Formula (III) 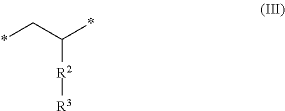
wherein
each R³ is a group of formula {—[N(R⁴)₂⁺]—R⁵}ᵥ—[N(R⁴)₃]⁺;
each R⁴ is an alkyl;
each R⁵ is an alkylene; and
the variable v is an integer in a range of 0 to 10;
each asterisk (*) represent a point of attachment of a repeat unit to another repeat unit or to a terminal group in the precursor polymer or the cationic polymer;
a counter anion is present to charge balance each cationic group;
c) forming a dispersion comprising particles of the cationic polymer;
d) preparing a coating layer from the dispersion; and
e) drying the coating layer to form the anion exchange membrane comprising the cationic polymer; and
wherein the amine compound comprising a tertiary amino group is of formula N(R⁴)₂—R⁵—{[N(R⁴)₃]⁺—R⁵}ᵥ₋₁—[N(R⁴)₃]⁺ where v is equal to at least 1.

2-3. (canceled)

4. The method of claim 1, wherein reacting the repeat units of Formula (II) of the precursor copolymer with the amine compound comprises forming a mixture, the mixture comprising (a) the precursor polymer dissolved in a non-polar solvent and (2) an aqueous-based solution comprising the amine compound.

5. The method of claim 1, wherein the dispersion is formed by subjecting a suspension to multiple passes through a microfluidizer, the suspension comprising (a) a liquid mixture comprising water and a polar organic solvent and (b) 1 to 20 weight percent cationic polymer based on a weight of the suspension.

6. The method of claim 1, wherein the particles of the cationic polymer in the dispersion have an average particle size that is less than 1000 nanometers or less than 500 nanometers.

7. The method of claim 1, wherein the dispersion comprising particles of the cationic polymer has 5 to 20 weight percent solids based on a total weight of the dispersion.

8. The method of claim 1, wherein preparing the coating layer comprises positioning the coating layer adjacent to a removable support layer.

9. The method of claim 1, wherein preparing the coating layer further comprises positioning a reinforcement material within the coating layer.

10. The method of claim 8, further comprising removing the removable support layer after drying the coating layer.

11. The method of claim 1, further comprising assembling an electrochemical device comprising the membrane, wherein the membrane is positioned between an anode and a cathode of the electrochemical device.
